(19) United States
(12) Patent Application Publication
(10) Pub. No.: US 2010/0109499 A1
(43) Pub. Date: May 6, 2010

(54) PAR STYLE LAMP HAVING SOLID STATE LIGHT SOURCE

(76) Inventors: Anthony W. Vilgiate, Carson, CA (US); Jet Patel, Rolling Hills Estates, CA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/264,026

(22) Filed: Nov. 3, 2008

(51) Int. Cl. H01J 61/94; H01J 61/52

(52) U.S. Cl. 313/1; 313/46

(57) ABSTRACT

A PAR style lamp is provided having a solid state light source, such as LEDs. The lamp includes a PAR-shaped housing, and an electrical contact carried by the housing and configured to receive input power. An illumination assembly is disposed in the housing and is electrically connected to the electrical contact to receive power. A heat dissipation assembly disposed in the housing and in thermal communication with the illumination assembly to facilitate the dissipation of heat during use of the lamp. The heat dissipation assembly is also electrically isolated from the illumination assembly.

### CROSS-REFERENCE TO RELATED APPLICATIONS

Not Applicable

### BACKGROUND

The present invention relates to lighting systems, and more particularly relates to PAR style lights having solid state light sources.

Parabolic aluminized reflector (PAR) style lamps have historically been used to provide general ambient illumination over a sizable area. Conventional PAR style lamps typically include an incandescent light source surrounded by a housing and covered by a transparent lens. While incandescent PAR style lamps are operable to provide generally oval pools of ambient light for their intended purpose, they are associated with several disadvantages.

For instance, the incandescent light sources are relatively energy inefficient, requiring 50 W of power or more during operation. Furthermore, they are subject to color inconsistencies. For instance, as the inert gas in the light source ages, the emitted light can fluctuate between warm colors (having red hue) and cool colors (having a blue hue). Moreover, incandescent light sources emit ultraviolet light which has damaging color fading effects on pictures, paintings, and like light-sensitive objects. Additionally, the incandescent light sources having fixed output patterns which emit oval pools of light with unfocused edges, and is incapable of being easily manipulated.

What is therefore needed is a PAR style lamp that overcomes the disadvantages associated with conventional PAR style lamps.

### SUMMARY

In accordance with one illustrative embodiment, a PAR style lamp includes a PAR-shaped housing, and an electrical contact supported by the housing. The electrical contact is configured to receive input power. The lamp further includes an illumination assembly disposed in the housing and electrically connected to the electrical contact. A heat dissipation assembly is carried by the housing. The heat dissipation assembly is in thermal communication with the illumination assembly, and the heat dissipation assembly is electrically isolated from the illumination assembly. The lamp further includes a lens configured to allow light emitted by the illumination assembly to pass through into an ambient environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description, is better understood when read in conjunction with the appended drawings. There is shown in the drawings example embodiments of various embodiments, however the present invention is not limited to the specific methods and instrumentalities disclosed. In the drawings:

FIG. 1 is a top perspective view of a PAR style lamp constructed in accordance with one embodiment;

FIG. 2 is a bottom perspective view of the PAR style lamp illustrated in FIG. 1;

FIG. 3 is a side elevation view of the PAR style lamp illustrated in FIG. 1;

FIG. 4 is an exploded perspective view of the PAR style lamp illustrated in FIG. 1;

FIG. 5 is a top plan view of the PAR style lamp assembled as illustrated in FIG. 4, but with the lens and the housing removed;

FIG. 6 is a sectional elevation view of the PAR style lamp taken along line 6-6 of FIG. 5, and as assembled as illustrated in FIG. 4, but with the housing removed and only a portion of the lens shown;

FIG. 7 is a side elevation view of the PAR style lamp assembled as illustrated in FIG. 4, but with the housing removed to illustrate internal components of the lamp;

FIG. 8 is a side elevation view of the PAR style lamp similar to FIG. 7, but showing additional portions of the housing;

FIG. 9 is a sectional elevation view of the PAR style lamp illustrated in FIG. 8, taken along line 9-9;

FIG. 10 is a sectional elevation view of the PAR style lamp illustrated in FIG. 3, taken along line 10-10;

FIG. 11 is a schematic illustration of the electronic circuitry of the PAR style lamp illustrated in FIG. 1; and

FIG. 12 is a top perspective view of a PAR style lamp constructed in accordance with an alternative embodiment.

### DETAILED DESCRIPTION OF ILLUSTRATIVE EMBODIMENTS

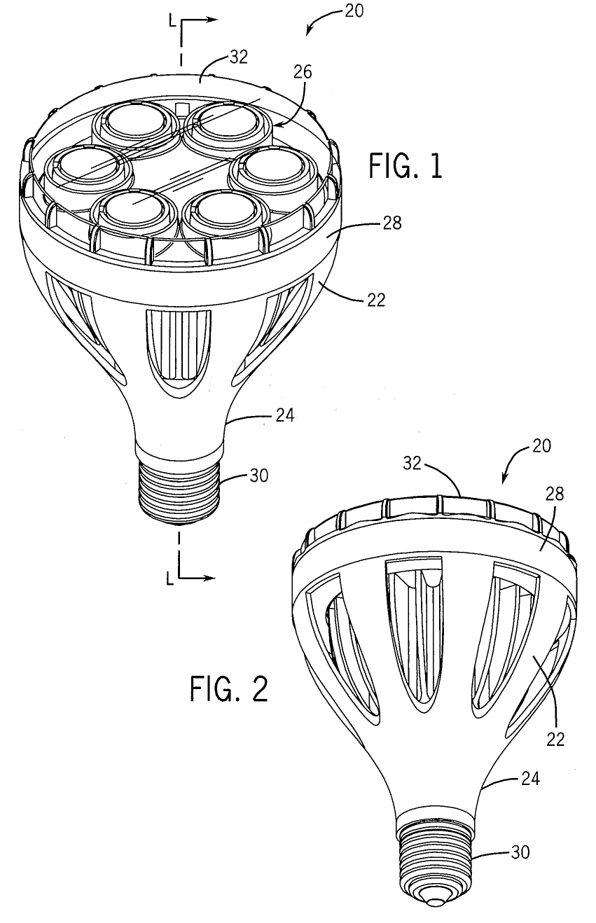

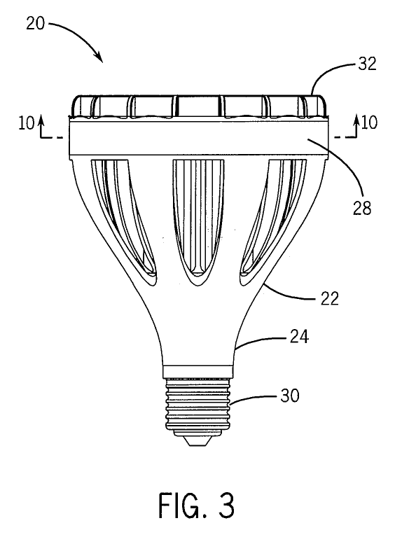

Referring to FIGS. 1-4, a solid state PAR style lamp 20 constructed in accordance with one embodiment extends along a centrally disposed longitudinal axis L-L, and includes a PAR-shaped housing 22 having a neck 24 at a lower end, and an opposing open upper end 28. The housing 22 retains or carries a driver assembly 50 that receives power from a power source and converts the power as desired, an illumination assembly 26 that receives the converted power and provides illumination, a heat dissipation assembly 80 that allows heat generated during operation of the lamp to escape, and an electrical isolation assembly 23 that allows heat to transfer between the illumination assembly 26 and the heat dissipation assembly 80 while preventing electrical current from flowing between the illumination assembly 26 and the heat dissipation assembly 80.

The housing 22 can be made from any suitable polymer such as polycarbonate or other electrically nonconductive material. The neck 24 can be connected to a conventional base 30, for instance what is typically known as an Edison screw base, which is configured to be threadedly received in a conventional PAR lamp socket (not shown) to facilitate power transfer to the light source(s). The open upper end 28 can be closed with an end cap assembly 31 having an output lens 32 that can be transparent or semitransparent to allow light emitted by the illumination assembly to pass through to the ambient environment. The lens 32 can be colored, textured, or include any light altering characteristic if desired. In the illustrated embodiment, the lens 32 is made of a clear plastic, though any suitable alternative material could be used. The illumination assembly 26 can include at least one, for instance one or more, solid state light sources provided as LEDs 40 that direct light through the output lens 32.

The lamp 20 is described herein as extending axially along the longitudinal axis L-L, and radially along a direction perpendicular to the longitudinal axis L-L. It should be appreciated that the longitudinal axis is referred to herein as extending along a vertical plane, and that the radial axis is referred to herein as extending along a horizontal plane, it being appreciated that the planes that encompass the various directions may differ during use, depending, for instance, on the desired directional and angular orientation of the links. Accordingly, the terms “vertical” and “horizontal” are used to describe the linkage as illustrated merely for the purposes of clarity and convenience, it being appreciated that these orientations may change during use.

As described herein, those components that are disposed in closer proximity to the longitudinal axis L-L other components are referred to as being disposed “inwardly” or “radially inwardly” or “inboard” with respect to the other components, while components that are disposed further from the longitudinal axis than other components are referred to as being disposed “outwardly” or “radially outwardly” or “outboard” with respect to the other components. Furthermore, the directional term “above” is used with reference to a direction from the base 30 towards the lens 32 along the longitudinal axis L-L, and the directional term “below” is used with reference to a direction from the lens 32 toward the base 30. Accordingly, those components closer proximity to the lens with respect to a distance along a longitudinal axis than another component can be said to be disposed “above” the other component, and vice versa. These directional terms are used for the purposes of form and clarity, it being appreciated that the actual position of the components of the lamp may change depending on the orientation of the lamp 20 during use.

Moreover, while the lamp 20 is described with reference to axial and radial directions, the present invention is not intended to be limited to such geometric descriptions. Accordingly, unless otherwise specified, the geometric configuration of the lamp could alternatively be described with respect to rectangular directions in accordance with certain aspects of the invention.

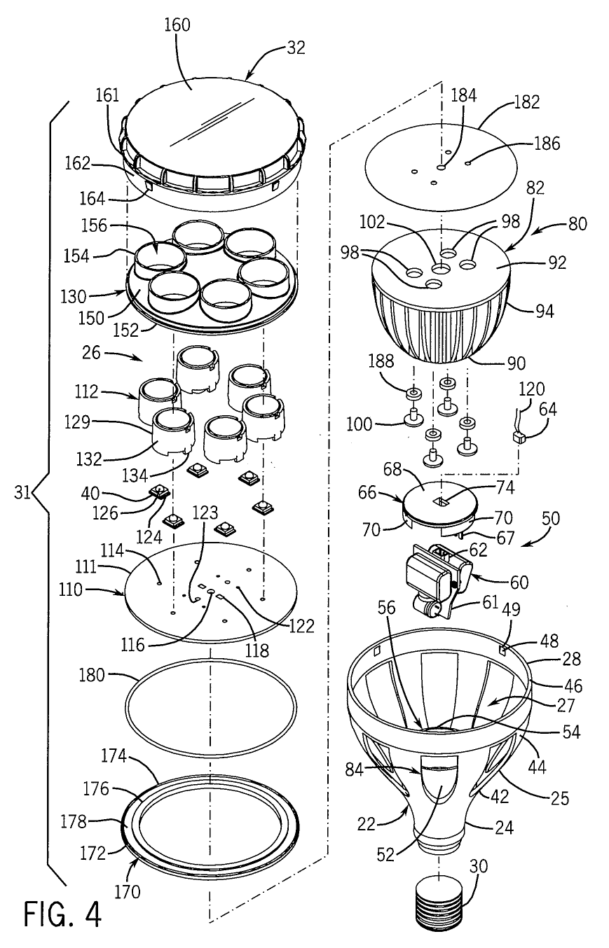

With particular reference now to FIG. 4, the housing 22 defines a curved and substantially parabolic body 25 typical of PAR style lamps. The body 25 includes the substantially cylindrical neck 24, a first curved portion 42 that flares radially outwardly, and is concave with respect to a horizontal plane (not shown) extending through the neck 24, and a second curved portion 44 that curves radially outwardly, and is convex with respect to a horizontal plane (not shown) extending through the neck 24. The second curved portion 44 is connected to a substantially longitudinally extending lip 46 disposed at its upper end.

The body 25 defines a plurality vents in the form of apertures 84 extending radially through the body to provide heat dissipation during use, as will be described in more detail below. The body 25 defines an internal void 27 defined in part by the open upper end 28. One or more engagement members 48 can be disposed on the housing 22, and particular on the radially inner surface of the lip 46.

In the illustrated embodiment, the engagement members 48 of the housing 22 can be in the form of recessed pockets having corresponding leading cam surfaces 49 positioned above the pockets. The engagement members 48 are thus configured to cooperate with, and receive, complementary engagement members 164 of lens 32 to affix the lens 32 at the open end 28 of the housing 22 and cover the internal void 27.

The lamp 20 further includes a driver assembly 50 that is supported by the housing 22 and disposed inside the internal void 27. In particular, the housing 22 includes a retainer wall 52 that extends above the neck 24 and is surrounded by the first curved portion 42 of the housing body 25. As illustrated, the retainer wall 52 is annular and extends vertically and is concentric about the longitudinal axis L-L. The retainer wall 52 terminates at an upper end 54 that is disposed below the lip 28, and is further disposed below the second curved body portion 44. The retainer wall 52, in combination with the housing body 25, defines a cylindrical cavity 56 having a closed lower end and an open upper end. It should be appreciated however, that the retainer wall 52 can have any size and shape, and can be positioned anywhere in the housing 22 in any orientation as desired.

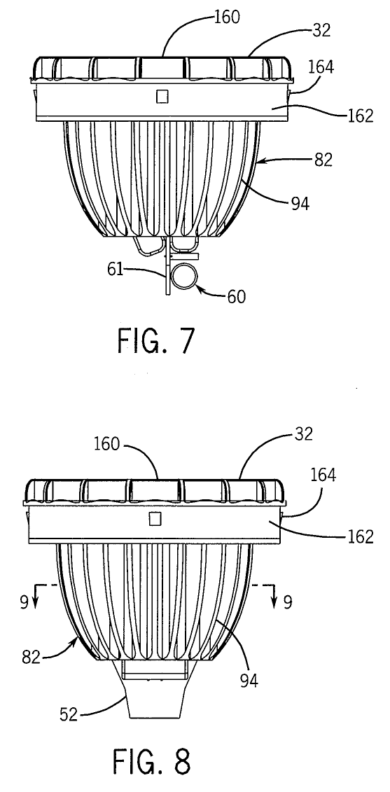

Referring also to FIGS. 7 and 8, the driver assembly 50 further includes an LED driver 60 having one end in electrical communication with the base 30 via electrical wires (not shown), and thus receives line power, or power from any suitable power source. The driver 60 further includes an electrical interface in the form of a receptacle 62 that provides power outlet configured to receive a plug 64 of electrical wires 120 that fits into the receptacle 62.

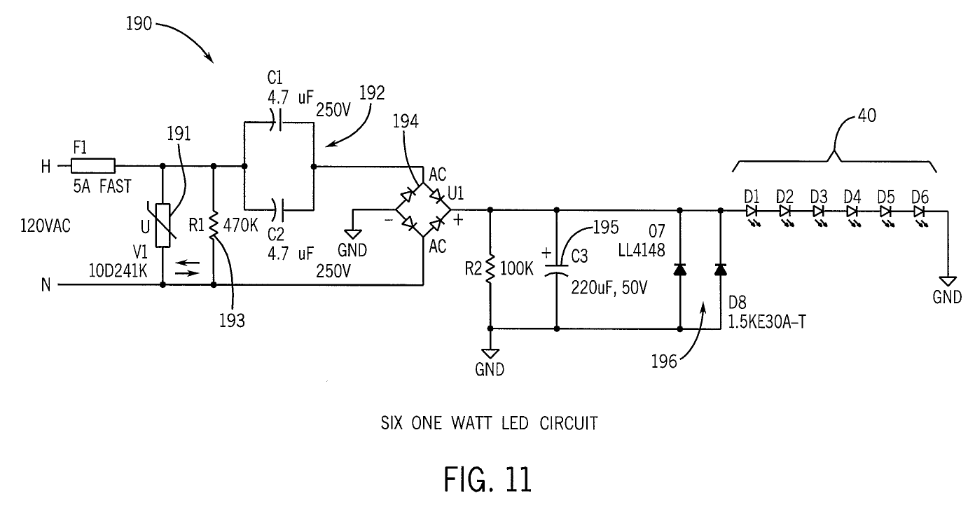

The driver 60 can include a circuit board 61 that carries circuitry 190 (described below with reference to FIG. 11) configured to manipulate the input power to achieve a desired output power to the light sources 40. The power output from the driver 60 can be configured to match with the electrical characteristics of the LED light sources. The driver 60 can further include pulse width modulation (PWM) circuitry to facilitate changes in light output characteristics (for instance dimming) if desired, and can be configured to comply with UL Class II isolation. While the driver 60 is configured to control all LEDs in concert in accordance with one embodiment, it should be appreciated that the driver 60 can alternatively include more than one channel if it is desired to provide independent control of LEDs or arrays of LED groupings.

The driver assembly 50 can further include an insulative cover 66 that mechanically isolates the driver from the remaining components of the lamp 20. The cover 66 can be in the form of a cylindrical plate 68 having a pair of flanges 70 extending down from the plate 68. The flanges 70 can be radially recessed with respect to the radially outer edge of the cover 66 by a distance substantially equal to the thickness of the retainer wall 52. The flanges 70 can assume any suitable geometric configuration, and is arc-shaped in accordance with one aspect of the invention, and sized slightly smaller than the retainer wall 52 such that the cover 66 can be press-fit in the retainer wall 52. The cover 66 can be sized such that when it is attached to the retainer wall 52, the outer edges of the cover 66 are substantially flush with the retainer wall 52.

The cover 66 can further include one or more plates 67 that extend down from the plate 68 radially inward with respect to the corresponding flanges 70. The plates 67 can attach to the circuit board 61 of the driver 60 via a screw or any alternative fastener to affix the driver to the cover 66 such that the driver extends down from the cover 66. A central opening 74 extends axially through the cover 66 to provide clearance for the insertion of the electrical plug 64. The driver 60 is attached to the cover 66 in a position such that the receptacle 62 is in alignment with the opening 74. The opening 74 can be sized only slightly greater than, or substantially equal to, the receptacle such that the plug 64 can fit snugly into the opening 74 when inserted into the receptacle 62.

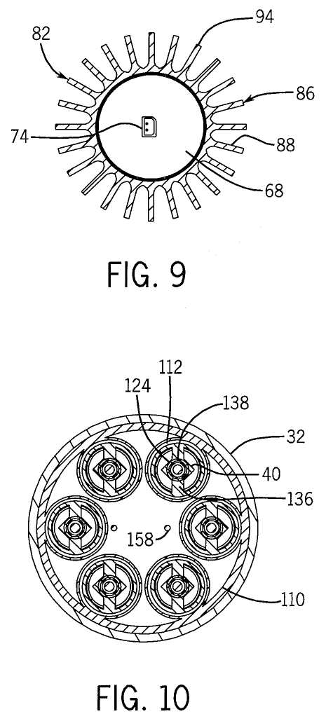

Referring now to FIGS. 4 and 6-9, The lamp 20 further includes a heat dissipation assembly 80, which can include a heat sink 82 and one or more vents 84 extending through the housing body 25. The heat sink 82 includes a body 86 having an annular hub 88, a cylindrical disk 92 disposed at the upper end of the hub 88, and a plurality of heat dissipation fins 94. The vents 84 provide for ambient airflow around the heat sink to assist in heat dissipation. The heat sink body 86 can be made of injection molded aluminum, or any suitable alternative material capable of dissipating heat generated during operation of the lamp 20.

The hub 88 extends between an open lower end 90 and an upper end that is closed by the cylindrical disk 92. The disk 92 has a diameter greater than that of lower end of the hub 88 and less than that of the upper curved portion 44 of the housing 22. The open lower end 90 can be cylindrical having an inner diameter slightly greater than or substantially equal to that of the retainer wall 52 and cylindrical plate 68. The cylindrical disk 92 has a diameter that is sized less than that of the housing body 25 at the location in axial alignment with the disk 92 such that the heat sink 82 can fit inside the housing body 25.

The plurality of heat dissipation fins 94 extend radially out from the cylindrical hub 88, and further extend axially between the lower end 90 and the disk 92. Twenty-four fins 94 equidistantly spaced 15° with respect to each other about the circumference of the hub 88 are provided, though it should be appreciated that any number of fins 94 may be provided as desired, and can be spaced regularly or irregularly about the hub 88. The fins 94 can have an airfoil shape with respect to a radius extending toward the center of the heat sink 82, however it should be easily appreciated that the fins could define any suitable alternative shape that provides for heat dissipation. In the illustrated embodiment, each fin 94 can include an outer surface 96 that has a decreasing radius of curvature in a direction from the disk 92 toward the lower end 90 to impart a parabolic shape onto the radially outer end of the body 86.

The heat sink 82 includes a plurality of apertures extending axially through the disk 92. For instance, a plurality of mounting apertures 98 is spaced about disk 92 that provide connection locations between the heat sink body 86 and other components of the PAR light 20. The mounting apertures 98 can be sized to receive a plurality of fasteners, which can be threaded such as screws 100. A central aperture 102 is radially aligned with the of the central opening 74 of the insulative cover 66, and is sized sufficiently large to receive the plug 64 so that the plug can extend through the cylindrical hub 88 and into the receptacle in the manner described above.

The heat sink 82 can be installed in the housing 24 by sliding the open lower end 90 of the heat sink body 86 over the cylindrical plate 68 and the retainer wall 52 until the lower end of the body 86 abuts the first curved portion 42 of the housing 24. When installed, the cylindrical disk 92 is disposed axially inward with respect to the housing lip 46 to provide space within the upper end of the void 27 for the insertion of the illumination assembly 26 and the electrical isolation assembly 23, as will now be described.

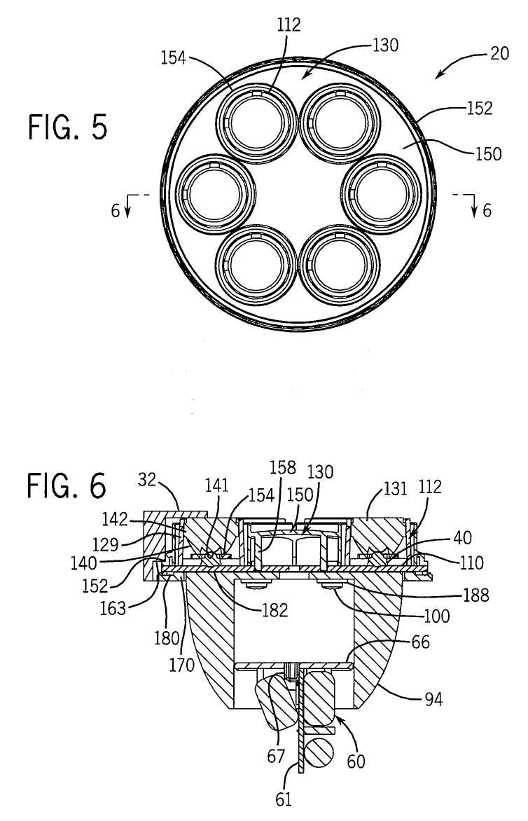

In particular, referring to FIGS. 4, 5, 6, and 10, the illumination assembly 26 can include a plurality of LED light sources 40 mounted onto a substrate 111, which can be provided as a printed circuit board 110 that directs power emitted from the driver 60 to the light sources 40, a corresponding plurality of optical lens assemblies 112 that can define optical characteristics of light emitted by the light sources 40, and a diffuser 130 that can eliminate glare from the light output by the light sources 40.

The circuit board 110 can be cylindrical in shape, and can be made from aluminum or any alternative suitable thermally conductive material. The circuit board 110 can have a diameter greater than that of the heat sink disk 92, and less than the inner diameter of the lens 32. The upper surface of the circuit board 110 includes electrical traces 114 each configured to connect to one of the light sources 40. Six electrical traces 114 equidistantly spaced 60° with respect to each other about the circumference of the circuit board 110 are provided, though it should be appreciated that any number of traces 114 may be provided as desired based, for instance, on the desired number of light sources 40, and can be spaced regularly or irregularly about the circuit board 110.

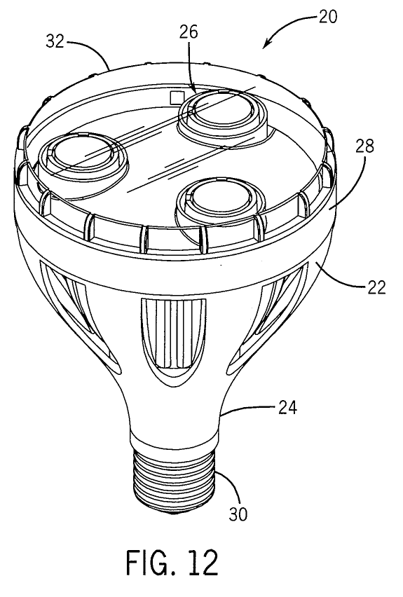

While the lamp 20 includes six light sources 40 equidistantly spaced circumferentially in the illustrated embodiment, it should be appreciated that the lamp in accordance with the can include any number of light sources spaced equidistantly or irregularly with respect to each other. For instance, FIG. 12 illustrates the lamp as including three equidistantly spaced light sources 40.

The circuit board 110 can further include a centrally disposed aperture 116 extending vertically through the circuit board, and a pair of electrical terminals 118 disposed on opposing sides of the aperture 116 on the upper surface of the board 110. The terminals 118 can electrically connect to the terminal ends of wires 120 that extend up from the plug 64. The wires 120 thus extend up through the aperture 116 and connect to the terminals 118. Electrical traces (not shown) extend through the circuit board 110 and electrically connect the terminals and the electrical traces 114 such that power output from the driver 60 is transmitted to the light sources 40 through the wires 120, the terminals 118, electrical traces, and electrical traces 114.

The circuit board 110 can further include a plurality of connection locations in the form of mounting apertures 122 that extend vertically through the circuit board. In the illustrated embodiment, the mounting apertures 122 are threaded and vertically aligned with the mounting apertures 98 of the heat sink 82 to facilitate assembly of the PAR lamp 20. A pair of locating apertures 123 can further extend vertically through the circuit board 110 to ensure that the circuit board is installed in the lens 32 at a desired position that provides proper alignment of the light sources in the illumination assembly 26.

As described above, the light sources 40 can be provided as light emitting diodes in the illustrated embodiment having a base 124 and a dome 126 extending up from the base. The dome 126 encapsulates the diode, and can be transparent or translucent such that the emitted light can pass through. The dome 126 can be made from plastic or any alternative suitable material. The base 124 can be provided as a heat resistant plastic that houses an electrical contact configured to connect to one of the electrical traces 114 on the printed circuit board 110. The base 124 can be square shaped as illustrated, or can comprise any suitable alternative geometry.

In one embodiment, the electrical contact of the light source 40 can be soldered to the trace such that the diode is in electrical communication with the electrical trace 114. It should be appreciated, however, that any suitable mechanism for facilitating the connection of the light source 40 to the circuit board that places the diode in electrical communication with the electrical trace 114 is contemplated.

Referring now to FIGS. 4 and 6, a plurality of optical lens assemblies 112 can be provided if desired, corresponding in number to one or more of the light sources 40. Accordingly, one or more, up to all, of the light sources 40 can be provided with a corresponding optical lens assembly 112 that shapes or forms the output light as desired. Each optical lens assembly includes a housing 129, which can be made of a heat-resistant plastic, and a lens 131 disposed in the housing. The lens 131 can be transparent or translucent, and can be made from a plastic or suitable alternative material. The lens assemblies 112 provide user-replaceable lens elements 131 that change the beam spread of the emitted light. Accordingly, the lamp 20 can provide a user-configurable light output.

The lens assembly housing 129 can include a substantially cylindrical body 132 and one or more legs 134 extending down from the body 132. The legs 134 can provide spacers configured rest on the upper surface of the printed circuit board 110 to provide a gap that accommodates the corresponding light source 40. Referring also to FIG. 10, two of the opposing legs 134 are connected to a retention member in the form of a beam 136 that extends across the lower end of the housing 129. The beam 136 defines an opening 138 that receives the base 124 of the corresponding light source 40. The opening 138 can be square shaped, and sized only slightly greater than the base 124 such that the position of the light source 40 is locked in place in the lens assembly 130. The housings 129 can be retained in place either by an adhesive, for instance epoxy (such as two-part epoxy commercially available from 3M), that attaches the housings to the circuit board 110 (or alternatively the lens 32). Alternatively, the housings 129 can be sandwiched between the circuit board 110 and lens 32 such that a sufficient force is placed on the housings 129 that prevent them from moving within the end cap assembly 31.

The lens 131 can be provided in any desired size and shape. As best shown in FIG. 6, the illustrated embodiment includes a lower frustum portion 140 and an upper cylindrical portion 142 extending up from the lower frustum portion. The upper cylindrical portion 142 has a diameter only slightly less than that of the lens assembly housing 129 such that the lens 131 can be press-fit inside the housing 129. When the lens is installed, the apex 141 of the lower frustum portion 140 is aligned with the opening of the beam 136. The apex 141 of the frustum portion 140 can be provided as a recess that is sized to receive the upper end of the dome 126 of the light source 40. Accordingly, during operation, light emitted from the light source 40 travels through the lens 131 before being directed out the PAR style lamp 20. The upper surface of the cylindrical portion 142 can be textured as desired to further define the output light characteristic.

Referring again to FIGS. 4 and 6, the diffuser 130 can be formed from any suitable plastic, and can be opaque or translucent and define any suitable alternative material properties suitable for eliminating glare from the light emitted by the light sources 40. In the illustrated embodiment, the diffuser 130 includes a substantially cylindrical plate 150 having a lip 152 disposed at the lower end of the plate 150 that extends radially out from the plate 150. In the illustrated embodiment, the plate 150 can be substantially dome-shaped and concave with respect to the printed circuit board 110.

A plurality of annular walls 154 extends vertically through the plate 150. The annular walls can correspond in number to the light sources 40. Accordingly, in the illustrated embodiment, six annular walls 154 can be equidistantly spaced 60° with respect to each other about the circumference of the plate, corresponding in number to the light sources 40, though it should be appreciated that any number of walls may be provided as desired, and can be spaced regularly or irregularly about the plate 150.

Each annular wall 154 defines a lower end co-planar with the lip. Each annular wall 154 further defines an upper end arranged such that the upper ends of the annular walls are co-planar. Each annular wall 154 further defines an internal cylindrical cavity 156 that extends through the plate 150 and is sized greater than the lens assembly housing 129 such that the light sources 40, and lens assembly 112 fit within the cavity 156. During operation, the annular walls 154 can shield the light sources 40 from direct view and blend the entire lambertian output of the light sources 40 and remove the point source glare associated with wide viewing angles (for instance, greater than 45 degrees off axis).

The diffuser 130 can include a pair of locating pins 158 that extend down from the lower surface of the plate 150. The locating pins 158 can be in alignment with the locating apertures 123 of the printed circuit board 110, and sized slightly less than the apertures 123 such that the fingers can be press-fit in the apertures 123. The pins 158 extend a distance below the lower ends 155 of the annular walls 154 a distance substantially equal to the vertical thickness of the printed circuit board 110 such that the pins 158 extend into, but not substantially below, the apertures 123.

Referring again to FIG. 4, the end cap assembly 31 can include a lens 32 as described above, and can further include a gasket 170 and a retaining ring 180. The gasket 170 is configured to attach to the lower end of the lens 32, and the retaining ring 172 seals the end cap assembly 31 to prevent liquid from entering into the illumination assembly 26.

The lens 32 includes a substantially cylindrical end plate 160 and a substantially annular wall 162 extending down from the radially outer end of the end plate 160. The end plate 160 and annular wall 162 can be integrally formed, and made from any suitable material, for instance a polymer such as polycarbonate. An inner lip 163 (see FIG. 6) can extend radially inward from the radially inner surface of the annular wall 162, such that the lip of the lens 32 is configured to abut the upper surface of the lip 152 of the diffuser 130, thereby locating the diffuser 130 in the end cap assembly 31 when the diffuser is installed in the end cap assembly 31. The annular wall 162 further includes one or more engagement members 164 configured to mate with corresponding engagement members 48 on the housing 22 when the PAR light 20 is assembled. The engagement members 164 can be in the form of projections that are configured to ride along the cam surface 49 and into the pocket of the engagement members 48 to affix the lens 32 to the housing 22. An outer lip 161 can project radially outward from the annular wall 162 at a location above the engagement members 164 so as to provide a stop that is configured to abut lip 46 of the housing 22 when the lens 32 is fully attached to the housing 22.

The gasket 170 can be made of plastic such as polycarbonate, or any suitable alternative material. The gasket can include an annular body 172 having an inner diameter slightly greater than the diameter of the heat sink disk 92, and an outer diameter sized to be substantially flush with that of the annular wall 162 of lens 32. An outer axial lip 174 can extend upwards from the radially outer end of the annular body 172 of the gasket, and an inner axial lip 176 can extend upwards from the radially inner end of the annular body 172. A groove 178 is thus disposed between the lips 174 and 176. The outer lip 174 is positioned to abut the bottom edge of the annular wall 162 of the lens 32 such that the groove 178 faces the lower surface of the printed circuit board 110 when the end cap assembly 31 is assembled. The groove 178 can be sized and positioned such that a radially inner portion of the groove 178 overlies the radially outer end of the printed circuit board 110, while the radially outer portion of the groove 178 is aligned with the bottom end of the annular wall 162 of the lens 32. Alternatively, the entirety of the groove 178 can be substantially or entirely aligned with the bottom end of the annular wall 162 of the lens 32.

The retaining ring 180 can be made of silicon or any suitable material capable of providing a seal for the end cap assembly 31. The ring 180 can be an annular ring having a diameter sufficient to fit into the groove 178 such that a portion of the ring 180 abuts the radially outer end of the printed circuit board 110, and a portion of the ring 180 abuts the bottom end of the annular wall 162. The retaining ring 180 can be ultrasonically welded to provide a water tight seal between the gasket 170 and the lens 32.

As described above, the PAR style lamp 20 includes an electrical isolation assembly 23. The illustrated embodiment recognizes that the heat sink 82 is exposed to the ambient environment to better facilitate heat dissipation during operation of the PAR style lamp 20. While the housing 22 guards the heat sink 82 with respect to tactile access by a user, the housing 22 may not prevent a user from touching the heat sink 82 in all instances. As a result, it is desirable to electrically isolate the printed circuit board 110 from the heat sink 82. At the same time, it is desirable to allow heat emitted by the illumination assembly 26 to readily transfer to the heat sink 82 so that the heat can be dissipated into the environment.

The electrical isolation assembly 23 in the illustrated embodiment can provide for thermal conductivity between the illumination assembly 26 to the heat sink 82 while at the same time preventing electrical conductivity between the illumination assembly 26 and the heat sink.

The isolation assembly 23 can include a thermally conductive and electrically isolating member such as a flexible dielectric film 182 that can be cylindrical in shape and dimensioned to prevent direct mechanical contact between the printed circuit board 110 and the heat sink 82. For instance, the film 182 can have a diameter slightly less than the inner diameter of the annular body 172 of gasket 170 such that the film 182 covers all, substantially all, or a portion of the lower surface of the printed circuit board 110 that extends radially inward from the gasket 170. Accordingly, when the illumination assembly 26 and heat sink 82 are installed in the lamp 20, the film 182 lays flat between and against the upper surface of the heat sink disk 92 and the lower surface of the printed circuit board 100. In this regard, the film 182 can provide a spacer member disposed that prevents mechanical contact between the printed circuit board 110 and the heat sink 82 when both are installed in the housing 22.

A central opening 184 can extend vertically through the film 182, and is disposed at the center of the film in the illustrated embodiment. The opening 184 can be sized to receive the wires 120 (and/or plug) to facilitate an electrical connection between the driver 60 and the illumination assembly 26. A plurality of apertures 186 also extends through the film 182, and surrounds the central opening 184 at locations in alignment with the mounting apertures 98 and 122 of the heat sink 82 and printed circuit board 100, respectively. The apertures 186 are sized to receive the fasteners 100.

In the illustrated embodiment, the film 182 is made from a 900-S silpad commercially available from Bergquist Company, located at 18930 W. 78th Street, Chanhassen, Minn. 55317. While the film 182 has been found to achieve thermal conductivity and electrical isolation, it should be appreciated by one having ordinary skill in the art that any suitable alternative material capable of achieving these properties is contemplated. Furthermore, while the heat sink 82 and printed circuit board 100 abut the film 182 in the illustrated embodiment, one skilled in the any alternative configuration is contemplated that provides for heat transfer from the illumination assembly 26 to the heat sink 82, and that further provides for electrical isolation between the illumination assembly 26 and the heat sink 82.

In one embodiment, the film 182 can provide a breakdown voltage within a range having a lower end between and including approximately 1700 Vac and 2500 Vac, and an upper end between and including approximately 5000 and 6000 Vac. In one embodiment, the film 182 has a breakdown voltage of approximately 5000 Vac. The film 182 can further provide a thermal conductivity within a range having a lower end between and including approximately 0.9 W/m-K and 1.3 W/m-K, and an upper end between and including approximately 3.0 W/m-K and 3.5 W/m-k. In one embodiment, the film 182 has a thermal conductivity of approximately 1.6 W/m-k.

The isolation assembly 23 can include one or more fasteners 100 that can mechanically connect the heat sink 82 to the illumination assembly 26 and locate the heat sink within the housing 22. The PAR style lamp 20 can further be configured such that the fasteners 100 do not establish a path of electricity between the illumination assembly 26 and the heat sink 82. For instance, in the illustrated embodiment, the mounting apertures 98 of the heat sink 82 are sized substantially greater than the screw shank such that each shank can pass through the corresponding aperture 98 without making contact with the portion of the heat sink disk 92 that defines the aperture 98.

A nonconductive washer 188 can have an inner diameter sized greater than the screw shank and less than the screw head. The outer diameter of the nonconductive washer 188 can be greater than the mounting aperture 98 of the heat sink. Accordingly, the washer 188 separates the fastener 100 from contact with the heat sink 82 when the screw 100 is inserted into the mounting apertures 122 of the printed circuit board 110. Furthermore, as the screw 100 is tightened, the screw head biases the washer 188 against the bottom surface of the heat sink disk 92, thereby creating a frictional retaining forces between the disk 92 and the surrounding washer(s) 188 and film 182 that prevent the heat sink 82 from moving and maintain the screws 100 in a position out of contact with the disk 92.

Assembly of the PAR style lamp 20 will now be described. It should be appreciated that certain of the steps described below may be performed before or after some or all of the other steps, or even concurrent with some or all of the other steps, while certain other steps need not be performed at all in order to provide a PAR style lamp 20 constructed in accordance with certain aspects described herein. One having ordinary skill in the art will therefore appreciate that the description below describes an assembly of the PAR style lamp 20 in accordance with only one embodiment, and that substantial deviations are intended to fall within the spirit and scope of the present invention.

The illumination assembly 26 can be assembled by attaching the LED light sources 40 to the printed circuit board 110 such that the electrical contact of each light source 40 is placed in electrical communication with the electrical traces 114. Next, the optical lenses 112 can be attached to the printed circuit board 110 such that the housing 129 surrounds the associated LED light sources 40. The diffuser 130 can then be installed in the lens 32 such that the lip 152 of the diffuser plate 150 abuts a corresponding lip (not shown) that extends radially inward from the radially inner surface of the annular wall 162. The diffuser 130 can thus be positioned such that the upper ends of the annular walls 154 are spaced slightly below (or could abut) the cylindrical end plate 160 of the lens 32.

The distal end of wires 120 can be fed upward through the central opening 184 of the film 182, and further through the central aperture 116 extending through the printed circuit board 110, and can electrically connected to the terminals 118 disposed on the upper surface of the printed circuit board 110. The circuit board 110 can then be inserted into the open lower end of the lens 32 such that the locating pins 158 of the diffuser extend into the corresponding locating apertures 123 that extend through the printed circuit board 110.

Next, the retaining ring 180 can be placed in the groove 178 of the gasket 170, and the gasket can be positioned such that the outer diameter of the annular body 172 is substantially flush with the annular wall 162 of the lens 32 and the retaining ring is at least partially aligned with the 10 with the bottom end of the annular wall 162 of the lens 32. The retaining ring 180 can then be ultrasonically welded to provide a water tight seal between the gasket 170 and the lens 32.

The driver assembly 50 can then be installed in the housing 22 by attaching the driver 60 to the insulative cover 66 such that the receptacle 62 of the driver 60 is aligned with the central opening 74 of the cover 66. The driver 60 can then be inserted into the retainer wall 52, and the upper end of the retainer wall can be closed by press-fitting the recessed flange 70 into the upper end of the retainer wall 52 until the cover 66 abuts the upper end of the retainer wall.

Next, the heat sink 82 can be mechanically connected to the illumination assembly 26. In particular, the dielectric film 182 is placed flat against the bottom surface of the printed circuit board 110 such that the apertures 186 extending through the film 182 are aligned with the mounting apertures 122 of the printed circuit board 110. The plug 64 of the electrical wires 120 can be inserted through the central aperture 102 of the heat sink 82, and the heat sink can be positioned such that the upper surface of the heat sink disk 92 abuts the bottom surface of the dielectric film 182. The heat sink 82 is oriented such that the mounting apertures 98 are aligned with the corresponding apertures 186 of the film 182, and further aligned with the corresponding mounting apertures 122 of the printed circuit board 110.

Next, the washers 188 can be positioned against the bottom surface of the heat sink disk 92 at each mounting aperture 98, and the screws 100 can be inserted through the corresponding washers and the mounting apertures 98 so that the screw shanks do not contact the heat sink 82. Furthermore, the washers 188 separate the screw heads from the heat sink disk 92. As a result, the screws 100 do not contact the heat sink 82. Once the screws 100 are inserted through the apertures 98, they can be threadedly fastened to the mounting apertures 122 of the printed circuit board 110. Because the screws 100 are electrically isolated from the heat sink 82, electrical current is prevented from flowing from the circuit board 100 to the heat sink.

It should be appreciated that many deviations from the illustrated embodiment are contemplated. For instance, the screws 100 could alternatively be threaded into the mounting apertures 98 of the heat sink 82 and be isolated with respect to contact with the printed circuit board 110. Alternatively still, the screws 100 can be made from a nonconductive material (for instance plastic) and can be threadedly inserted into both sets of mounting apertures 98 and 122 to electrically isolate the heat sink 82 and the circuit board 110. Alternatively still, an adhesive or any alternative fastener could couple the heat sink 82 to the dielectric film 82. Alternatively still, the heat sink 82 could be fastened to the housing 22 at a location that places the heat sink disk 98 against the dielectric film 82. It should thus be appreciated that any retention member that locates the heat sink 82 in a position to be in thermal communication with, and electrically isolated from, the illumination assembly 26 is contemplated.

Once the heat sink 82 has been mechanically coupled to the illumination assembly 26, the plug 64 can be inserted into the central receptacle 62 of the driver 60 via the opening 74 of the cover 66, thereby placing the illumination assembly 26 in electrical communication with the base 30. The end cap assembly 31, which retains the illumination assembly 26, and the heat sink 82 can then be inserted into the housing such that the cylindrical hub 88 of the heat sink 92 fits over the cover 66 and retainer wall 52. The end cap assembly 31 is inserted until the engagement members 164 of the lens 32 mate with the complementary engagement members 48 of the housing 22. The outer lip 161 is configured to abut the lip 46 of the housing 22 to prevent the lens 32 from being over-inserted. It should be appreciated that while the engagement members 48 are provided as pockets and engagement members 164 are provided as projections, any alternative engagement member suitable for attaching the lens 32 to the housing 22 is contemplated.

The base 30 provides an electrical contact that can be placed in electrical communication with an electrical power source, for instance by screwing the base 30 into a conventional socket, which causes power to transmitted through the driver 60 and circuit board 110 to the light sources 40 to illuminate the diode encapsulated by the dome 126. Referring now to FIG. 11, the driver 60 can include a circuit board 61 having internal circuitry 190 that carries one or more elements configured to control power received from the base 30. For instance, the circuitry 190 can include a varistor 191 that is configured to eliminate voltage spikes received from the power source, such as a 120V AC power source. A pair of capacitors 192 is provided in parallel that limit the current flow through the circuitry 190 and eventually to the light sources 40. A resistor 193 can be provided to discharge the capacitors 192 so that a user will not be exposed to live voltage when the lamp 20 is removed from the power receptacle.

A full bridge rectifier 194 can be provided that converts the AC power to DC power of a predetermined amperage, for instance 35 mA. A third capacitor 195 can be provided that absorbs additional power spikes that happen to pass through the remaining upstream circuitry components. For instance, power spikes can occur when the light is initially turned on. A resistor 196 can be provided that is configured to drain the capacitor 195. Finally, a pair of transient suppression diodes 196 can be arranged in parallel and configured to shunt current that is above a predetermined voltage to ground. The current then travels through the light sources 40 to illuminate the associated diodes of the light sources 40.

During operation of the lamp 20, as heat is produced by the illumination assembly 31, and in particular by the light sources 40, the heat travels through the circuit board 110 to the dielectric film 182, and further through the dielectric film 182 to the heat sink 82. The heat sink 82 dissipates the heat into the ambient environment through the vents 84 that are formed in the housing 22. The fins 94 increase the surface area of the heat sink body 86, thereby increasing the efficiency of heat dissipation. Because the dielectric film 182 is not electrically conductive, electricity is prevented from flowing from the illumination assembly 31 to the heat sink body 86. The present inventors have found that in the illustrated embodiment, a power surge of up to 2500 VAC flowing through the printed circuit board 110 will not travel to the heat sink 82.

While apparatus and methods have been described and illustrated with reference to specific embodiments, those skilled in the art will recognize that modification and variations can be made without departing from the principles described above and set forth in the following claims. Accordingly, reference should be made to the following claims as describing the scope of the present invention.

What is claimed:

1 A PAR style lamp comprising:
a PAR-shaped housing;
an electrical contact supported by the housing, wherein the electrical contact is configured to receive power;
an illumination assembly disposed in the housing and electrically connected to the electrical contact;
a heat dissipation assembly carried by the housing, wherein the heat dissipation assembly is in thermal communication with the illumination assembly, and he heat dissipation assembly is electrically isolated from the illumination assembly; and
an output lens configured to allow light emitted by the illumination assembly to pass through into an ambient environment.

2. The PAR style lamp as recited in claim 1, wherein the heat dissipation assembly further comprising a heat sink separated from the illumination assembly by a dielectric film, and the dielectric film allows heat to transfer between the illumination assembly and the heat sink, and the dielectric film electrically isolates the illumination assembly from the heat sink.

3. The PAR style lamp as recited in claim 1, wherein the illumination assembly comprises at least one solid state light source.

4. The PAR style lamp as recited in claim 3, wherein the at least one solid state light source comprises an LED.

5. The PAR style lamp as recited in claim 4, wherein the at least one solid state light source is mounted onto a thermally conductive substrate, and the heat dissipation assembly comprises a heat sink that is separated from the printed circuit board by a dielectric film.

6. The PAR style lamp as recited in claim 5, wherein the heat sink comprises a plurality of fins extending out from a heat sink body.

7. The PAR style lamp as recited in claim 5, wherein the heat sink is mounted to the substrate with at least one fastener that is configured to prevent current from flowing from the substrate to the heat sink.

8. The PAR style lamp as recited in claim 5, wherein the housing comprises a plurality of vents providing for airflow around the heat sink.

9. The PAR style lamp as recited in claim 4, wherein a plurality of LEDs are spaced circumferentially about a center.

10. The PAR style lamp as recited in claim 4, wherein the LEDs are equidistantly spaced.

11. The PAR style lamp as recited in claim 4, further comprising a diffuser disposed between the at least one LED and the output lens.

12. The PAR style lamp as recited in claim 11, further comprising an optical lens disposed between the at least one LED and the diffuser.

13. The PAR style lamp, wherein the at least one LED is mounted onto a substrate, and the lamp further comprises further comprising a gasket and sealing ring configured to seal the gasket against the substrate so as to retain the illumination assembly in a fixed position relative to the output lens.

14. The PAR style lamp as recited in claim 1, further comprising a driver configured to receive input power from the contact, configure the input power, and provide output power to the illumination assembly.

15. A PAR style lamp comprising:
a PAR-shaped housing;
an electrical contact supported by the housing and configured to receive power;
an illumination assembly disposed in the housing and electrically connected to the electrical contact, the illumination assembly including a plurality of solid state light sources supported by a substrate and placed in electrical communication with the electrical contact;
a lens configured to allow light emitted by the illumination assembly to pass through into an ambient environment.
a heat sink carried by the housing, and a thermally conductive and electrically isolating member disposed between the heat sink and the substrate such that heat can transfer from the substrate to the heat sink, and current is unable to flow from the substrate to the heat sink.

16. The PAR style lamp as recited in claim 15, wherein the thermally conductive and electrically isolating member comprises a dielectric film disposed between the heat sink and the substrate.

17. The PAR style lamp as recited in claim 16, wherein the heat sink and substrate abut opposing surfaces of the dielectric film.

18. The PAR style lamp as recited in claim 17, wherein the heat sink is mounted to the substrate by at least one fastener configured so as to not facilitate electrical communication between the substrate and the heat sink.

19. The PAR style lamp as recited in claim 15, wherein the heat sink is disposed inside the housing, and the housing comprises a plurality of vents in alignment with the heat sink.
